(19) United States
(12) Patent Application Publication
(10) Pub. No.: US 2024/0159940 A1
(43) Pub. Date: May 16, 2024

(54) ELEMENT MADE OF BRITTLE MATERIAL HAVING A STRUCTURED EDGE, INTERMEDIATE PRODUCT, AND METHOD FOR PRODUCING THE ELEMENT

(71) Applicant: Schott AG, Mainz (DE)

(72) Inventors: Andreas Ortner, Gau-Algesheim (DE); Fabian Wagner, Mainz (DE); Markus Heiss-Chouquet, Bischofsheim (DE); Vanessa Glässer, Mainz (DE); Heong Leong Teoh, Simpang Ampat (MY); Shiuh Liang Lee, Sungai Petani (MY); Michael Drisch, Mainz (DE); Ulrich Peuchert, Bodenheim (DE); Guangjun Zhang, Shanghai (CH)

(73) Assignee: Schott AG, Mainz (DE)

(21) Appl. No.: 18/394,514

(22) Filed: Dec. 22, 2023

Related U.S. Application Data
(63) Continuation of application No. PCT/EP2022/066222, filed on Jun. 14, 2022.

(30) Foreign Application Priority Data
Jun. 24, 2021 (DE) 10 2021 116 398.6
Jun. 14, 2022 (WO) PCT/EP2022/066222

(51) Int. Cl. G02B 1/115; C03C 15/00; C03C 23/00

(52) U.S. Cl. CPC G02B 1/115; C03C 15/00; C03C 23/0025

(57) ABSTRACT

A sheet-like element made of brittle material includes two opposing side faces and a peripheral edge face which determines an outer contour of the sheet-like element. The edge face has at least one first region and at least one second region. The at least one first region differs from the at least one second region in terms of its surface structure. The at least one first region has an etched surface and the at least one second region constitutes a fractured surface. A surface area of the at least one first region is larger than a surface area of the at least one second region. The at least one first region and the at least one second region are arranged next to one another in a direction along the edge face.

### CROSS REFERENCE TO RELATED APPLICATIONS

This is a continuation of International Patent Application No. PCT/EP2022/066222 entitled “ELEMENT MADE OF BRITTLE MATERIAL HAVING A STRUCTURED EDGE, INTERMEDIATE PRODUCT, AND METHOD FOR PRODUCING THE ELEMENT,” filed on Jun. 14, 2022, which is incorporated in its entirety herein by reference. International Patent Application No. PCT/EP2022/066222 claims priority to German Patent Application No. 10 2021 116 398.6 filed on Jun. 24, 2021, which is incorporated in its entirety herein by reference.

### BACKGROUND OF THE INVENTION

### 1. Field of the Invention

The invention relates generally to the production of elements made of brittle material. In particular, the invention relates to the production of such elements by working contours out of a sheet-like workpiece.

### 2. Description of the Related Art

US 2018/215647 A1 describes a method for introducing continuous channels into a plate-like glass element by an ultrashort-pulse laser, the pulses of which are shaped by a focusing optical unit, and a subsequent etching process, which removes the mutually adjacent channels from one another by etching away the material bridges in between, with the result that a structured component with a predefined geometry and special edge features (“calottes”) is leached out and produced. This method makes it possible to work glass or glass ceramic elements, even with complex contours, out of a sheet.

U.S. Ser. No. 10/941,069 B2 describes a processing method for a plate-like workpiece having a layer made of glass or glass ceramic, the workpiece being broken down into multiple incompletely separated partial segments by selective laser etching, wherein the partial segments initially remain connected to the rest of the workpiece by a web-like connection, wherein this residual connection is also configured on the top and the bottom side with an undercut, that is to say has a structured configuration (only in one subregion of the thickness).

U.S. Ser. No. 10/626,040 B2 discloses a sheet-like glass article which has been structured with two damage regions, wherein the second damage region has at least one interruption, and which is singulated after an etching process. The damage regions may partially overlap and are made in the material by a laser process, which may also involve ultrashort pulses.

The process described in US 2018/215647 A1 allows the structuring of transparent substrates made of glass or glass ceramic, generally made of brittle materials, in a processing process consisting of two steps, by initially introducing a chain of modifications into the substrate along the desired structures in the lateral direction by an ultrashort-pulse laser, the modifications being enlarged in the second step by a optionally alkaline etching process until the modifications are spatially connected and the inner and the outer part are present separately in the etching bath. If, however, a multiplicity of products with a small lateral magnitude are manufactured from the starting substrate, a handling problem arises to the effect that the smallest leached-out products float around in the etching medium and settle on the bottom of the etching tank, and can no longer be fed controllably to the further process steps. The glass parts become covered, and the results are uncontrolled etching processes, damage upon further handling, and, in general, considerable quality fluctuations in manufacture. The invention is therefore based on the object of producing small components of glass and glass ceramic by laser-assisted etching with a uniform quality, and in so doing at the same time make it easier to handle them during the production and for further processing. The basic idea here is that the small product produced by the laser-based contour definition step and subsequent etching remains connected to an adjacent retaining portion or further adjacent products by at least one web-like connection. The retaining portion may fix one or more small structured products in place and be realized in a multiplicity of geometric shapes, such as one or more strips or an encircling frame.

### SUMMARY OF THE INVENTION

In some embodiments provided according to the invention, a sheet-like element made of brittle material includes two opposing side faces and a peripheral edge face which determines an outer contour of the sheet-like element. The edge face has at least one first region and at least one second region. The at least one first region differs from the at least one second region in terms of its surface structure. The at least one first region has an etched surface and the at least one second region constitutes a fractured surface. A surface area of the at least one first region is larger than a surface area of the at least one second region. The at least one first region and the at least one second region are arranged next to one another in a direction along the edge face.

In some embodiments provided according to the invention, a sheet-like intermediate product made of brittle material for producing a sheet-like element includes a retaining portion an element connected to the retaining portion via at least one connecting portion. The element and the at least one connecting portion have an edge face with an etched surface. A width of the at least one connecting portion at a transition to the element is smaller than a length of a contour formed by the edge face with the etched surface, with the result that, by virtue of separating the element by fracturing the brittle material at the at least one connecting portion, it is possible to obtain a separate element made of brittle material, the edge face of which has at least one first region and at least one second region. The at least one first region differs from the at least one second region in terms of its surface structure. The at least one first region has an etched surface and the at least one second region constitutes a fractured surface. A surface area of the at least one first region is larger than a surface area of the at least one second region. The at least one first region and the at least one second region are arranged next to one another in a direction along the edge face.

In some embodiments provided according to the invention, a method for producing a sheet-like element made of brittle material includes: providing a sheet made of brittle material; irradiating the sheet made of brittle material with a laser, the brittle material of the sheet being at least partially transparent to the laser, a laser beam of the laser causing material modifications inside the sheet and the laser beam is guided over the sheet along a path so that the material modifications lie next to one another on the path; subjecting the sheet to an etching process after irradiating the sheet, the material modifications being enlarged by the etching process to form channels which are lastly connected, with the result that the sheet is separated along the path and the path defines a contour of an element which is connected to a retaining portion via a connecting portion, with the result that a sheet-like intermediate product is obtained; and separating the connecting portion so that the element is detached from the retaining portion.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a perspective view of a sheet-like element made of brittle material;

FIG. 2 shows a detail of a surface structure of a first region;

FIG. 3 shows different variants of intermediate products with elements made of brittle material, each of which is connected to a retaining portion;

FIGS. 4 to 6 show embodiments of respective multiple elements made of brittle material that are connected to a common retaining portion;

FIG. 7 illustrates method steps for producing an element made of brittle material;

FIG. 8 shows an exemplary embodiment of an intermediate product subdivided into regions;

FIG. 9 shows a device for producing an intermediate product made of brittle material;

FIG. 10 shows a plan view of an element made of brittle material;

FIG. 11 shows, for the element from FIG. 10, a diagram of the distance of the position of the edge face to the centroid as a function of the travel along the contour of the element;

FIG. 12 shows an example of an intermediate product with an element made of brittle material in the form of a gearwheel;

FIG. 13 shows a height profile of an edge face;

FIGS. 14 and 15 are optical micrographs of an element made of glass;

FIGS. 16 and 17 show two electron micrographs of the edge face of an element made of brittle material;

FIG. 18 shows a camera module;

FIG. 19 shows Weibull diagrams of the breaking strength of glass elements;

FIG. 20 shows an intermediate product with a rectangular element made of brittle material;

FIG. 21 shows an exemplary embodiment with an element made of brittle material;

FIG. 22 shows an example of an electro-optical arrangement with an element;

FIG. 23 shows an arrangement with an intermediate product on a carrier for separating elements; and

FIG. 24 shows a further arrangement for separating an element from a retaining portion.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The invention provides a sheet-like element made of brittle material, having two opposing, in particular parallel side faces and a peripheral edge face, which determines the outer contour of the sheet-like element, wherein the edge face has at least one first region and at least one second region, wherein the first region differs from the second region in terms of its surface structure. In this respect, the first region in particular has an etched surface. The second region constitutes a fractured surface. The surface area of the at least one first region is larger than the surface area of the at least one second region. If there are multiple first and second regions, this condition correspondingly applies to the sum of the surface areas. Accordingly, in this case, the total surface area of the first regions is larger than the total surface area of the second regions. In particular, the first and second regions are arranged next to one another along the edge face, or along the contour defined by the edge face. Exemplary brittle materials are glass ceramic and in particular glass.

The element made of brittle material is produced by separating a larger intermediate product. The handling of the element is made considerably easier by the connection in the intermediate product.

Accordingly, the invention also provides a sheet-like intermediate product made of brittle material for producing the element, wherein the intermediate product has a retaining portion and an element connected to the retaining portion via at least one connecting portion, wherein the element and the connecting portion have an edge face with an etched surface. The width of the connecting portion at the transition to the element is smaller than the length of the contour formed by the edge face with the etched surface, with the result that, by virtue of separating the element by fracturing the brittle material at the connecting portion, it is possible to obtain a separate element made of brittle material, the edge face of which has at least one first region and at least one second region, wherein the first region differs from the second region in terms of its surface structure, wherein the first region has an etched surface, and wherein the second region constitutes a fractured surface, and wherein the surface area of the at least one first region is larger than the surface area of the at least one second region, and wherein the first and second regions are arranged next to one another in a direction along the edge face, or the outer contour defined by the edge face.

The intermediate product made of brittle material may be produced by a method in the course of which a sheet made of brittle material is provided and irradiated with a laser, wherein the brittle material of the sheet is at least partially transparent to the laser, wherein the laser beam of the laser causes material modifications inside the sheet. The laser beam is guided over the sheet along a path, so that the material modifications lie next to one another on the path. The sheet is then subjected to an etching process, wherein the material modifications are enlarged by the etching process to form channels which are lastly connected, with the result that the sheet is separated along the path. The path defines the contour of an element which is connected to the retaining portion via a connecting portion, with the result that a sheet-like intermediate product in accordance with this disclosure is obtained. To produce a sheet-like element made of brittle material, the connecting portion can then be separated, so that the element is detached from the retaining portion.

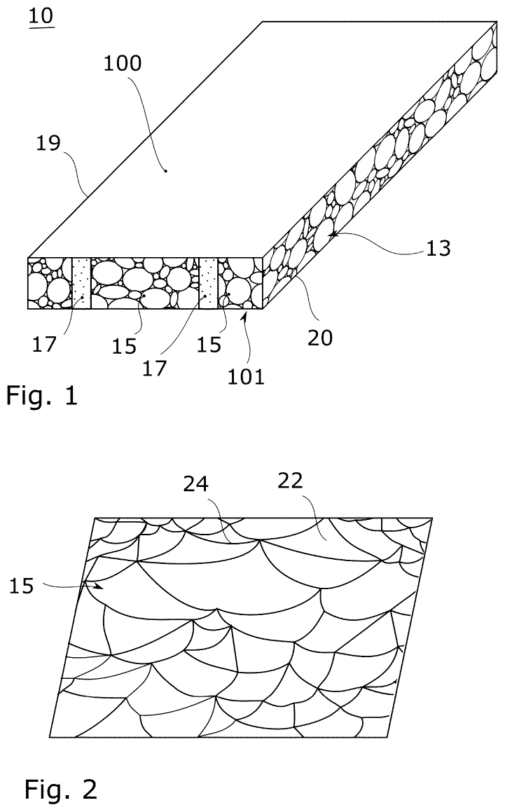

Referring now to the drawings, FIG. 1 shows a perspective view of a sheet-like element 10 made of brittle material. Brittle materials that come into consideration are generally especially glass and glass ceramic. These materials are distinguished, among other things, by a generally high transparency, for example of on average more than 80% in the range from 270 nm to 2700 nm, this facilitating the exemplary production, explained in more detail below, by a laser-assisted etching process. The sheet-like element 10 made of brittle material has two opposing, in particular parallel side faces 100, 101. The outer contour of the element 10 is formed by a peripheral edge face 13. The edge face 13 is subdivided into different portions, or regions, arranged next to one another. In this respect, at least one first region 15 and at least one second region 17 are present. These two types of regions differ in terms of their surfaces. Specifically, the first region 15 has an etched surface. The second region 17, by contrast, is a fractured surface. In this case, the surface area of the one or more first regions 15 is larger than the surface area of the one or more second regions 17. The regions are not arranged one on top of another in the form of strips which extend parallel to the side faces 100, 101 and lie one on top of another, but instead lie next to one another along the trace of the contour, that is to say along the edge face 13. Accordingly, the one or more second regions 17 of the edge face 13 adjoin at least one of the edges 19, 20 at which the edge face 13 merges into the side faces 100, 101.

In the example illustrated, there are two second regions 17. Since the second regions 17 are spaced apart from one another, between these two second regions 17 there is a first region 15 with an etched surface. A further first region extends along the edge face 13 around the element 10 and adjoins the second regions 17 at each of the two transitions that face away from one another. It is possible to provide only a single second region 17. If the edge face is not otherwise treated, it is then also the case that only one single first region 15 is present. Exemplarily, however, is an embodiment which has two or more mutually spaced apart second regions 17, like in the example illustrated. This may be advantageous in order to enable a stable connection to the retaining portion given easy separability of the element 10. For the same reason, in some embodiments it is intended that the at least one second region 17, or the multiple second regions 17 together, have a width of at least 0.5%, optionally at least one percent, of the largest lateral dimension of the element 10. In the example of FIG. 1 with the rectangular contour of the element 10, the largest lateral dimension is therefore given by the length of a diagonal between two opposite corners. The width of the second region 17, or the total width of multiple second regions, should be at least 20 μm, optionally at least 50 μm, optionally at least 100 μm.

The etched surface of the first region, which takes up the largest part of the edge surface 13, is generally advantageous since such an edge face 13 has high stability, that is to say a high (mechanical) (edge) strength. Therefore, it is otherwise generally the case, without being restricted to the specific illustrated example, that an exemplary embodiment provides that the sum of all the area percentages of the one or more first regions 15 takes up a proportion of the overall surface area of the edge face 13 of at least 90%, optionally at least 95%, optionally at least 98%, in particular at least 99%.

Because the strength of a glass part is essentially determined by the properties of its surface, in particular by the microcracks extending from the surface into the substrate material, the strength of the small component produced according to the invention is characterized by a generally high strength in most of the surfaces subjected to the etching process (leaching-out process).

According to some embodiments, the strength of the element 10 with respect to torsional loading of the edge face 13 can be higher, in particular significantly higher, in a first region than in a second region 17. A significantly higher strength is understood to mean a strength which is on average at least 50 MPa higher. As a result, according to some embodiments, a glass element, at an edge which has been pre-damaged by filamentation with an ultrashort-pulse laser and then fractured, has a measured characteristic strength of 80-200 MPa. When combined with an etching process and thus the formation of a surface as in a first region, it has a measured characteristic strength of more than 150 MPa to 500 MPa. Here, the characteristic strength σ_{c} is given by fitting a two-parameter Weibull distribution to the experimentally ascertained data according to the maximum likelihood method.

If, therefore, an element 10 produced according to this disclosure is tested with respect to the strength of individual sides/edges, for example by 3-point or 4-point bending or a stepped roller, there is a significant difference in the characteristic strengths between the edges having a second region (i.e. removed/fractured retaining webs) and edges without a second region. The surfaces in the second regions that were exposed by removing the connecting webs, or retaining portions, have a lower mechanical strength and can therefore be used or provided as intended fracturing points.

Even though there is a lower strength in the region of the surface exposed by separating, that is to say the fractured surfaces of the one or more second regions 17, the small component still retains a high strength. As mentioned, there is also the possibility of using the one or more second regions 17 as intended fracturing points and taking them into account from a structural perspective.

A further advantage of the subdivision of the edge face 13 into at least one first and at least one second region 15, 17 is the possible alignment. Thus, the second region may serve as orientation mark for component alignment. For example, a robot can identify this second region and take it as a basis for gripping or installing the element 10 with the intended orientation. As a result, given an asymmetrical alignment of the second region 17 in relation to axes of symmetry of the element, a robot can also determine how the side faces are oriented, for instance which side face is on the top. This can be important, among other things, if there is damage to one of the side faces.

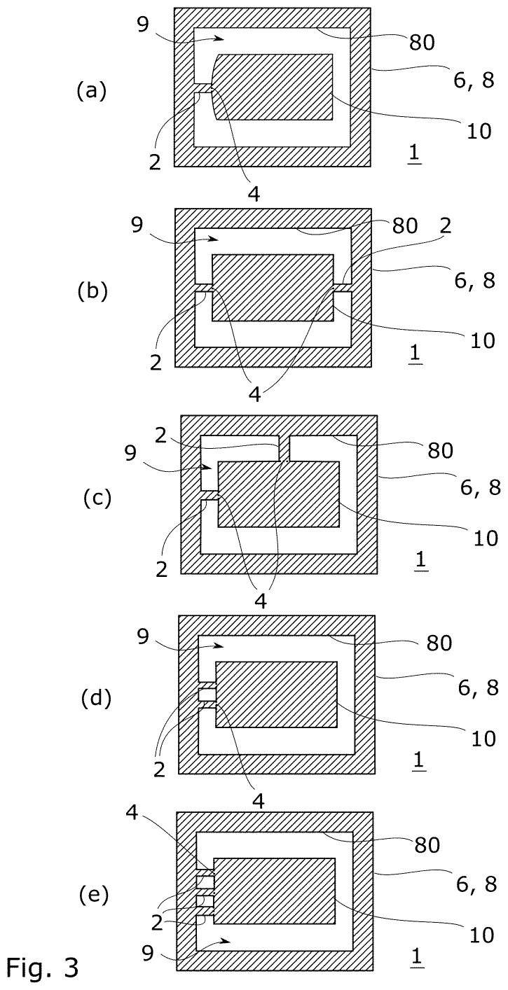

The number of such second regions 17 that are introduced as fractured surfaces and have a modified strength should be minimized in some embodiments. In general, it is favorable if the number of connecting portions and thus second regions is at most 50, optionally at most 10, optionally at most 5, and optionally at most 3. In an exemplary configuration, the structuring is effected such that the small part is connected to the retaining portion by one or two connecting portions. As explained below on the basis of FIG. 3, multiple connecting portions may fix the small part in place from different directions, and in an exemplary embodiment from the same direction, or even parallel, for stability reasons. In an exemplary embodiment, the small part, or element 10, is connected to the retaining portion by parallel connecting portions, optionally two parallel connecting portions.

The two types of regions 15, 17 may also differ in terms of different features than the surface finish. Thus, the edge face in the two regions may form different angles to the side faces 100, 101. For example, in the one or more first regions 15, there may be a taper angle at the two edges 19, 29 owing to the etching process. The fracturing operation can also cause the second region 17 to have an inclination, so that one edge projects and/or the other edge is recessed. The first and second regions 15, 17 may, in addition to different surface structures, also have different edge geometries or edge shapes.

In general, a taper angle of the edge face in a first region is also created by the direction in which the laser beam is radiated in. In this case, filamentary damage extending obliquely in the material is caused, with the result that, during the etching operation, an edge face with a surface which is correspondingly oblique along the direction of the filaments is produced.

The different surface structures of the first and second regions 15, 17 may differ, among other things, in terms of one of the following features: roughness, reflectance, visual appearance. According to some embodiments, although the two regions 15, 17 are distinguishable, they have the same visual appearance or at least visual appearances that are indistinguishable with the naked eye.

The element 10 is optionally in the form of a small product, for instance for precision-mechanical or micromechanical applications, such as for example design and functional elements, for example for the clock and watch industry, packaging (encapsulation) components for optoelectronic light emitters or encapsulation components for optoelectronic sensors. Optionally, to this end, the largest lateral dimension of the element is at most 100 mm, optionally at most 80 mm, optionally at most 50 mm. Smaller components with a largest lateral dimension of 30 mm can also be produced. Furthermore, largest lateral dimensions above 0.3 mm, in particular above 1 mm, optionally above 3 mm, optionally above 5 mm, may be preferred.

FIG. 2 shows a detail of the surface structure of a first region according to some embodiments. In general, it may be preferred if the etched surface of the first region 15 has calotte-shaped depressions 22. In particular, the calotte-shaped depressions may also more or less directly adjoin one another, with the result that adjacent depressions 22 are separated by ridges 24. The depth of the calotte-shaped, or rounded, depressions is optionally less than 5 μm. According to some embodiments, the lateral dimensions of the depressions 22 are on average in the range from 5 μm to 200 μm, optionally from 5 μm to 100 μm, in particular from 5 μm to 50 μm, optionally from 5 μm to 20 μm. In this respect, according to some embodiments the ridges 24 form polygonal boundaries of the calotte-shaped depressions 22 when seen in plan view of the first region 15.

The average lateral dimension of the calotte-shaped depressions may be influenced by the duration of the etching process. The calotte-shaped depressions are typically created at low rates of material removal and optionally using alkaline etching media, for instance KOH or NaOH solutions. Etching with an acidic etching medium is also possible, however. According to some embodiments, the material is removed at a rate of less than 15 μm, optionally less than 10 μm, optionally less than 8 μm per hour. Depending on how much material is removed after the channels created along the filamentary damage are unified, the channels are still recognizable as laterally open, adjoining channels, or in the reverse case as ribs, on the edge of the sheet-like element. These ribs remain upright where the channels abut one another during the etching operation. If, after the unification of the channels, etching continues to be performed, these structures even out and the result is a surface which, apart from the calotte-shaped depressions, does not have a superstructure in the form of half-open channels or ribs. Optionally, the mean number of sides of the polygons formed by the ridges is less than eight, optionally less than seven. The ridges 24 are relatively sharp in comparison with the curvature of the calotte-shaped depressions. This also means that the area percentage of convexly curved regions, as they must be present for instance in the middle of the ridge, is only small. The area percentage of convexly curved regions of the etched surface is optionally less than 5%, in particular less than 2%.

The structure, which is caused in particular by a low etching rate, of the surface is distinguished generally by high edge strengths, this being especially advantageous for small components subject to mechanical loads.

The properties of such a surface and its production are described in U.S. Patent Application Publication No. 2018/215647 A1, which is also incorporated in its entirety in the subject matter of the present application with respect to the laser-assisted etching method and the surface structure created by the method.

FIG. 3 shows, in subimages (a) to (e), different embodiments of structured, sheet-like intermediate products 1 made of brittle material. The intermediate products each have, as separable material portion, an element 10 which is connected to a retaining portion 6 via a connecting portion 2 in the form of a optionally web-like material bridge. In all the embodiments illustrated, the retaining portion 6 here is in the form of a frame. In this case, the element 10 is arranged inside the frame 8, or inside the opening 9 defined by the frame 8, and is connected to the frame 8, or more generally to the retaining portion 6, via one or more connecting portions 2. In the example of subimage (a), the element 10 is connected to the frame 8 via a single connecting portion 2 in the form of a web. For production-related reasons, the inner-edge face 80 of the opening 9 of the frame-like retaining element 6 generally has the same surface structure as the first region 19 of the edge face 13 of the sheet-like element 10, that is to say an in particular similar etched surface. This is advantageous, since in this way the frame 8 is also given high stability.

In order to increase the mechanical stability of the separated element (10), according to some embodiments which is also realized in the example of FIG. 3, subimage (a), the contour of the element 10 is convexly shaped, or outwardly curved, adjoining the second region 17. This geometry reduces the tensile forces arising in the second region 17 compared to a straight contour or a concave contour when mechanical loading is applied.

In the example of subimage (b), to retain the element 10, there are two connecting portions 2 which engage on opposite sides of the element. Two material bridges, or connecting portions 2, are also provided in the examples of subimages (c) and (d). In this case, in example (c), the connecting portions 2 retain the element 10 on two different sides. Expressed differently, the longitudinal directions of the material bridges 2 are transverse, in particular perpendicular, in relation to one another here. In example (d), the connecting portions, or material bridges 2, are arranged next to one another. The longitudinal directions of these connecting portions 2 are therefore substantially parallel.

In order that the retaining portion 6 can confer the necessary mechanical stability on the produced elements, or small or very small products, according to some embodiments but without being restricted to the specific illustrated examples, it is larger in terms of at least one lateral dimension than the connecting portion 2 and/or the element 10.

For mechanical stability reasons, the connecting portion 2 according to some embodiments generally, without being restricted to particular examples, has a width of at least half a percent (0.5%), optionally at least one percent, of the largest lateral dimension of the attached very small product, or of the glass or glass ceramic element 10, but according to yet another alternative or additional embodiment has a width of 100 μm. In order to enable good separability of the element 10, it may also be preferred if the width of the connecting portion is at most 50%, optionally at most 30%, optionally at most 20%, optionally at most 10%, of the largest lateral dimension of the retaining portion 6 or of the glass or glass ceramic element 10 connected to the connecting portion 2.

For good separability of the element 10 from the retaining portion 6, for the one part, and yet stable retention of the element 10, according to yet another embodiment it may be preferred if, in the case of at least two connecting portions 2 retaining one element 10, the mutual distance between them is at least half, optionally at least the same size as, optionally at least twice, the thickness of the intermediate produce 1, or of the element 10. Mutual distance here means the interspace between the edges of the connecting portions 2. Accordingly, according to this embodiment, it is then also possible for the width of the first region 15 between the two second regions 17 to be at least twice the thickness of the element 10 in the example shown in FIG. 1. According to yet another alternative or additional embodiment, the mutual distance between the connecting portions is at least 20 μm.

Even more than two connecting portions 2 may also be provided. To this end, subimage (e) of FIG. 3 shows an example of an embodiment in which an element 10 is connected to the retaining portion 6 by three connecting portions 2. It may be preferred here, too, if the connecting portions 2 extend substantially in parallel. As explained above, however, it may be advantageous, without being restricted to the illustrated examples, if only a small number of connecting portions is provided. As also in the case of the examples shown, it holds true that it may be advantageous if the number of connecting portions is at most 50, in particular at most 10, optionally at most 5 and optionally between 1 and 3. Often, a single connecting portion 2 is sufficient.

If multiple elements 10 of different types and dimensions are connected to the retaining portion 6, the aforementioned dimensioning is optionally provided for each element with an associated connecting portion 2.

The small component, or the element 10, is separated in the simplest case purely mechanically, that is to say by introducing a mechanical stress at the position of transition from the element 10 to the connecting element 2. Separating processes carried out in this way can, however, cause tearing cracks in the small component or the connecting element 2, with the result that small material projections or chip-like indentations/incisions remain on the contour of the element 10. In order to avoid such defects, the transition region between the connecting element and the small component can be structured by selectively introducing preliminary damage with the aim of controlling the stress profile and thus the crack profile. Methods known from the prior art, such as mechanical scoring or else laser-based methods like ablation, stealth dicing, laser-based thermal separation or filamentation along the desired separation line, can be used for this. According to some embodiments, a weakening structure 4 extending along the intended separation line between the connecting portion 2 and the element 10 is thus provided, as also shown in FIG. 3.

In particular, the weakening structure 4 may be structured between the connecting portion 2 and the small component, or element 10, by a filamentation process, during which a chain of through-holes with a diameter typically measured in sub-microns or filamentary damage, which can also be in the form of through-holes, is introduced along the desired contour or separation line at a predefined spacing by a focused ultrashort-pulse laser. To this end, according to some embodiments, the already structured intermediate product 1, with retaining portion 6, connecting element 2 and element 10, can be introduced into an ultrashort-pulse laser facility and correspondingly processed. A fractured edge pre-treated by such filamentation is advantageous compared with a fractured edge prepared without a weakening structure, for instance, since it is possible to separate it from the connecting portion 2 with a smaller force. The force necessary for separation is also almost always the same and the edges are virtually not visually distinctive. By contrast, in the case of a non-filamented edge, it is instead the case that visible chipping occurs on the surface. It is necessary to apply considerably greater force, which also increases the risk of damaging the actual element 10.

In some embodiments, these additional modifications are introduced perpendicularly in relation to the direction of extent of the one or more connecting elements and in addition to the already existing contour.

Furthermore, it is alternatively or additionally also possible for the weakening structure 4 to comprise a region of lower thickness. For example, such a reduction in thickness can be effected by laser ablation.

Yet another possibility is to insert a score line, for example using a scoring tool, such as a scoring wheel or a scoring diamond.

It is optionally provided that the weakening structure 4 is made in a separate method step after the contour of the intermediate product 1 has been worked out, that is to say after the etching process. The weaking structure may, for example, be in the form of a continuous or interrupted trench on at least one of the two surfaces (and thus a local thinning), a perforation (for example by filamentation using an ultrashort-pulse laser) or by internal modification, such as in the case of what is referred to as stealth dicing. In general, the weakening structure can be seen with an optical microscope or electron microscope.

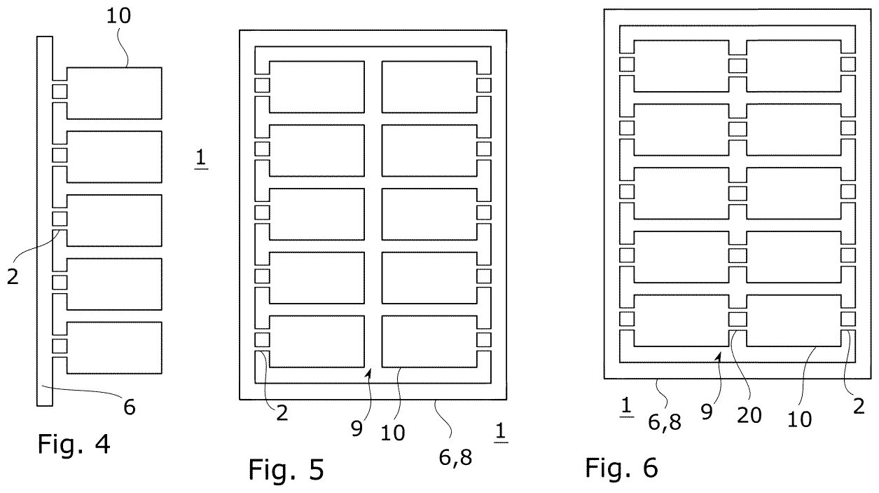

FIGS. 4 to 6 show embodiments of intermediate products 1 in the form of structured sheets made of brittle material, each of which has multiple elements 10 connected to a common retaining portion 6. In the embodiment according to FIG. 4, the retaining portion 6 has a strip-like form. The retaining portion 6 thus does not surround the elements 10 annularly or in the manner of a frame in this case. As a result, at least one edge of the element 10 is exposed, and the retaining portion 6 does not prevent access. This can be advantageous, for instance, if the glass or glass ceramic elements 10 are gripped with tongs and separated from the retaining portion 6. For example, a tool in the form of tongs may be provided as constituent part of a robot in the case of automated manufacture.

In the example of FIG. 5, multiple glass or glass ceramic elements 10 are arranged in a matrix arrangement inside a common opening 9 in the retaining portion 6, which is in the form of a frame 8. According to some embodiments, the glass or glass ceramic elements 10 are arranged on the retaining portion 6 in the form of a frame 8 in a side-by-side arrangement, in particular in a matrix arrangement with more than one row of elements 10. Exemplary is an arrangement of two rows inside an opening 9 in the frame, as in the example illustrated. This makes it possible to separately fasten the elements 10 on opposite sides of the opening by the connecting portions 2. As shown, multiple, in particular two, connecting portions 2 per element 10 may be provided. Similarly to the example of FIG. 3, subimage (d), here two connecting portions 2 extending in parallel are provided. The embodiments shown here, with two in particular parallel, web-like connecting portions 2, are exemplary, but less or even more than two connecting portions per small component may also be used. In the example of FIG. 6, a general embodiment is realized, in which at least two elements 10 are arranged inside the opening 9 of a retaining portion 6 that is in the form of a frame 8, wherein the two elements 10 are connected to one another by at least one connecting portion 20, which extends from one element 10 to the other element 10.

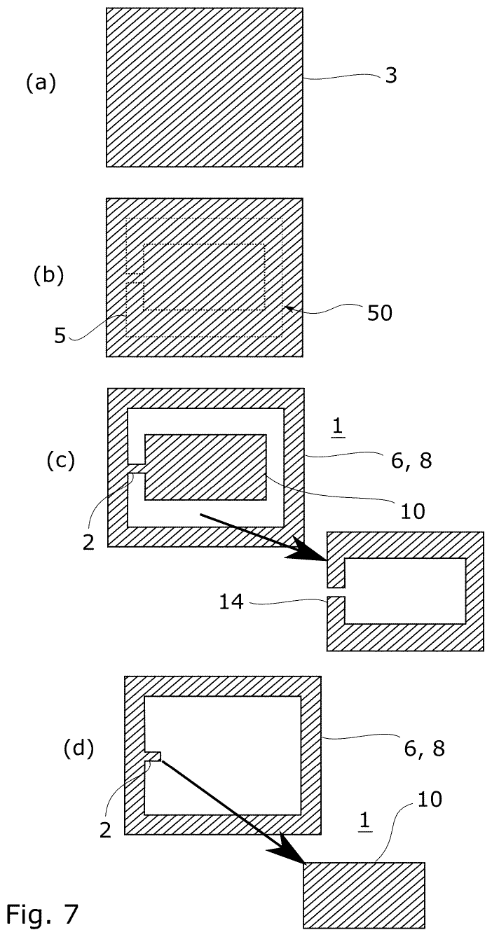

FIG. 7 illustrates method steps for producing an element 10 made of brittle material according to this disclosure, and as illustrated as an example in FIG. 1. In general, without being restricted to the specific illustrated examples, the method for producing an intermediate product 1 and the method for producing a sheet-like element 10 made of brittle material are based on the following steps: A sheet 3 made of brittle material is provided, as shown in FIG. 7, subimage (a).

The brittle material under consideration is in particular glass or glass ceramic, specifically: alkaline-free (AF) glass, borosilicate glass, glasses with the product designations AF32, AF35, AS87, D263, D263T, B270, MEMPAX, Willow, G-Leaf, EN-A1, BDA-E.

Particularly suitable glasses for the production method using laser radiation, the formation of filamentary damage, and subsequent etching with unification of enlarging channels along the filamentary damage are listed below.

According to some embodiments, the composition of the glass comprises the following constituents, in percent by weight:

| Composition | (% by wt.) |
|---|---|
| SiO₂ | 63-85 |
| Al₂O₃ | 0-10 |
| B₂0₃ | 5-20 |
| Li₂O + Na₂O + K₂O | 2-14 |
| MgO + CaO + SrO + BaO + ZnO | 0-12 |
| TiO₂ + ZrO₂ | 0-5 |
| P₂O₅ | 0-2 |

According to some embodiments, the composition of the glass of the element 10 comprises the following constituents:

| Composition | (% by wt.) |
|---|---|
| SiO₂ | 60-84 |
| Al₂0₃ | 0-10 |
| B₂O₃ | 3-18 |
| Li₂O + Na₂O + K₂O | 5-20 |
| MgO + CaO + SrO + BaO + ZnO | 0-15 |
| TiO₂ + ZrO₂ | 0-4 |
| P₂O₅ | 0-2 |

According to some embodiments, the composition of the glass comprises the following constituents:

| Composition | (% by wt.) |
|---|---|
| SiO₂ | 58-65 |
| Al₂O₃ | 14-25 |
| B₂O₃ | 6-10.5 |
| MgO + CaO + SrO + BaO + ZnO | 8-18 |
| ZnO | 0-2 |

A further suitable composition of the glass for the element 10 is given by:

| Composition | (% by wt.) |
|---|---|
| SiO₂ | 50-81 |
| Al₂O₃ | 0-5 |
| B₂O₃ | 0-5 |
| Li₂O + Na₂O + K₂O | 5-28 |
| MgO + CaO + SrO + BaO + ZnO | 5-25 |
| TiO₂ + ZrO₂ | 0-6 |
| P₂O₅ | 0-2 |

According to some embodiments, the composition of the glass of the element 10 comprises the following constituents:

| | |
|---|---|
| SiO₂ | 52-66 |
| B₂O₃ | 0-8 |
| Al₂O₃ | 15-25 |
| MgO + CaO + SrO + BaO + ZnO | 0-6 |
| ZrO₂ | 0-2.5 |
| Li2O + Na2O + K2O | 4-30 |
| TiO₂ + CeO₂ | 0-2.5 |

For all the aforementioned glass compositions, it holds true that, if appropriate, coloring oxides may be added, such as Nd₂O₃, Fe₂O₃, COO, NiO, V₂O₅, MnO₂, CuO, Cr₂O₃. 0-2% by wt. As₂O₃, Sb₂O₃, SnO₂, SO₃, Cl, F and/or CeO₂ may be added as refining agents, and the total amount of the composition as a whole is 100% by weight in each case.

In general, the thickness of the sheet 3 is optionally in the range of 20 μm to 6000 μm, optionally in the range to 5000 μm, optionally in the range from 20 μm to 3000 μm. In a first step, the contour of the retaining and connecting element and of the small product, or element 10, is defined. The sheet 3 made of brittle material is irradiated with a laser for this, wherein the brittle material of the sheet 3 is at least partially transparent to the laser, and wherein the laser beam of the laser causes material modifications 5 inside the sheet 3. The laser beam is guided over the sheet 3 along a path 50, so that the material modifications lie next to one another on the path 50. FIG. 7, subimage (b) shows the sheet 3 with material modifications lying next to one another on the path 50. In this respect, modifications can be understood to mean material changes, such as in particular changes in refractive index (in locally delimited or continuous fashion), local material thinnings in the form of trenches, score lines, cavities, internal damage in the substrate like microcracks, local fusing, continuous holes (with a cylindrical or more general shape) or filaments, or filamentary damage.

In order to separate the portions of the substrate that are required for the retaining portion 6, connecting element 2 and small product, or element 10, from unnecessary, excess portions, in the next step the modifications present are intensified, that is to say enlarged, by an etching process in such a way that the modified regions touch or overlap and thus a continuous, uninterrupted weaking of material or even separation is carried out along the intended contour. The sheet 3 is thus then subjected to an etching process, wherein the material modifications 5 are enlarged by the etching process to form channels which are lastly connected, with the result that the sheet 3 is separated along the path 50. The path 50 defines the contour of an element 10 which is connected to a retaining portion 8 via a connecting portion 2. As a result, after separation along the path, a sheet-like intermediate product 1 according to this disclosure is obtained.

The etching can be performed with an acidic etching medium, such as aqueous solutions of HF, HCl, H₂SO₄, HNO₃ or other acids. Etching with an alkaline etching medium, such as with potassium hydroxide solution, KOH, or sodium hydroxide solution, NaOH. According to some embodiments, it is provided that the etching is effected in an alkaline etching medium with a pH greater than 12 and a complexing agent. Here, the complexing agent is selected such that it complexes at least one of the constituents of the brittle material. According to some embodiments, it is provided to use a complexing agent which forms complexes with alkaline earth metal ions, optionally calcium ions (Ca²⁺). According to yet another refinement, a complexing agent is selected from the group of phosphates, optionally ATMP (nitrilotrismethylenephosphonic acid), phosphonic acids, salts of hydroxycarboxylic acids, optionally alkali metal gluconates, EDTA, and/or transition metal salts, in particular CrCl₃. The features above can advantageously counteract local inhibition of the etching operation by complexing leached-out constituents. Rather, even within the structures to be created, a self-stabilizing or even self-reinforcing effect in terms of the etching rate can occur.

It is furthermore also possible to use an etching solution which contains a silicate, optionally an alkali silicate, optionally water glass, in dissolved form. If etching solutions containing dissolved silicates are used, the etching rate can be significantly increased. This effect can be observed in particular at high silicate concentrations in the etching solution. In particular at high silicate concentrations, the silicates moreover act as transferers of alkali and thus increase the mobility, or ionic mobility, of the hydroxide ions. This is advantageous in particular for embodiments featuring a very high hydroxide concentration in the etching solution. In the case of very concentrated alkali solutions, accordingly, the ionic mobility of the hydroxide ions decreases as the concentration goes up, with consequences for the etching rate as well. By adding silicates as alkali transferers, however, this effect can be at least partly compensated.

If the etching process results in the sheet 3 being separated along the path 50 simulating the contour of the element 10 and the connecting portion 2, an element 14 that complements the element 10 with the connecting portion 2 is detached from the sheet 3. Portions of the substrate that are not required thus fall out of the structured substrate in parts (for example, if auxiliary steps are also inserted prior to the etching) or as a whole during the etching process. At the end of this step, there is a component consisting of one or more retaining portions, one or more small products and their single or multiple connections to the retaining elements or one another. A characteristic of this component is in particular the surface structure resulting from the etching process.

By detaching this element 14, the intermediate product 1 is obtained. This is illustrated in FIG. 7, subimage (c). In a different way to what is illustrated, the contour of the element 10 may also be formed without leaching out a complementary element 14, for instance in that only the contour is followed by the laser beam as path and then a narrow slot is etched away along the path in the etching process. Furthermore, it is also possible to leach out multiple small parts instead of a single complementary element 14 in order to work the element 10 out.

At the end of the process sequence is the separating step, in which the small component, or element 10, is separated from its connecting elements along a defined separation line. Accordingly, also provided is a method for producing an element 10, in the course of which the connecting portion 2 is separated after the intermediate product 1 is produced, so that the element 10 is detached from the retaining portion 6. Subimage (d) of FIG. 7 shows this step.

It may be particularly advantageous if the step shown in FIG. 7 subimage (d) is carried out temporally separate from the production of the intermediate product, that is to say considerably later and/or at a different location, for example for the incorporation of the element 10 in a device provided for this, for example after a storage or transportation process. An advantage of an intermediate product 1 produced in this way is that the later small product, or element 10, is positionally stabilized and thus can be easily processed further by processing the intermediate product as a whole directly or using additional handling aids. Further process steps, without any claim to completeness, may be: coating surfaces or parts of the surfaces, printing, restructuring, or else combinations of these. According to yet another embodiment, the intermediate product 1 may be chemically prestressed. In this refinement, too, the bond of the element 10 to the retaining portion 6 facilitates handling. For chemical prestressing, it is generally favorable to use an alkali-containing brittle material, such as a glass or a glass ceramic with a sufficiently high Na₂O content. Optionally, the Na₂O content is at least 5% by wt. for this purpose. In order to facilitate the separation of the element 10 from the retaining portion 6 at the connecting portion 2 even in the chemically prestressed state, according to some embodiments it is advantageous here if the width of the connecting portion 2 is smaller than twice the depth of layer (DoL). In this case, the connecting portion 2 is chemically prestressed over its entire cross-sectional area, so that the risk of an uncontrolled fracture owing to stresses which vary along the fracture is reduced. According to another refinement, it is also possible for the width of the connecting portion 2 to be smaller than four times the exchange depth, or optionally smaller than three times the depth of layer (DoL). This is expedient specifically in the case of thicker glasses, in order both to still enable nondestructive separation and to delimit the depth of layer. According to yet another embodiment, a channel, for example with a length of 10 μm, may be provided on the connecting portion 2. The exchange bath may penetrate the channel, with the result that chemical prestressing is also generated around this channel. In this way, the transition region between the connecting portion and the element 10 can likewise be chemically prestressed in the volume to the extent that high stress differences at the fracture point are avoided. The at least one channel can, like the weaking structures 4 shown in FIG. 1, be introduced both into a side face and into the edge face.

At the end of the separating process step, there are retaining portions with connecting elements and the small components, or elements 10, are separate. In this respect, the side faces 100, 101 may also have been subjected to structuring or other forms of further processing.

As already explained on the basis of FIG. 1, the surface exposed by the separating process has a second surface structure different to that in the first regions that were exposed by the etching process, for example in the case of prior mechanical separation a smooth surface, or in the case of laser perforation by a filamentation process typically a visually rough surface through which pass the opened, perpendicularly extending filamentation channels. The edge face 13 of the element 10 has, for each former connecting portion 2, one second region 17 with the area percentage corresponding to the cross section of the connecting portion 2 in the region of contact between the connecting portion 2 and the element 10. Therefore, the sum of the surface proportions of the one or more second regions 17 on the overall surface area of the edge face 13 is considerably smaller than the sum of the proportions of the first regions 15. Optionally, the proportion of the second regions 17 is less than 20%, optionally less than 10%, optionally less than 5%. An area percentage of less than 2% and in particular less than 1% may be preferable.

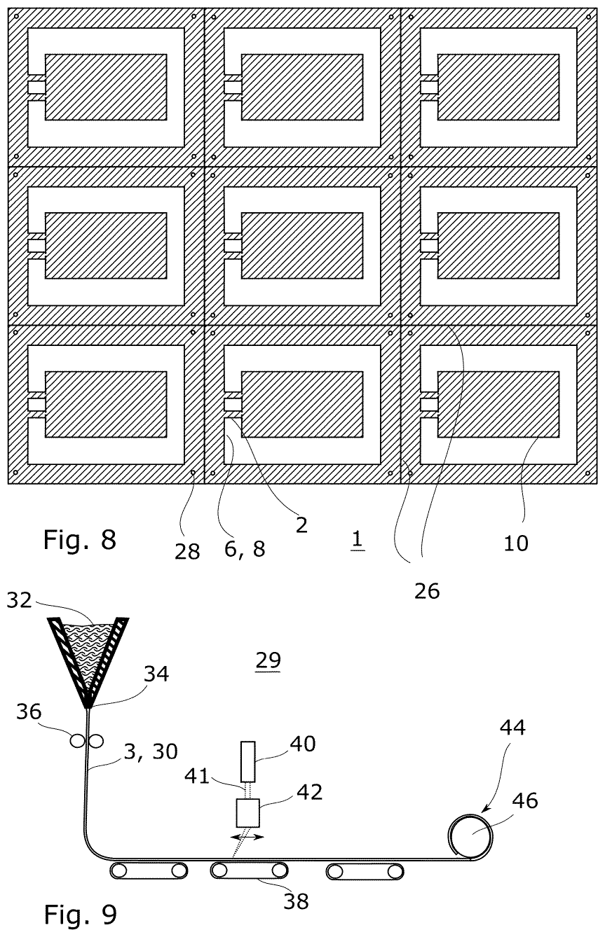

FIG. 8 shows an example of one embodiment of an intermediate product 1 subdivided into regions. This embodiment makes it possible to manufacture the small component, or element 10, located in the frame 8 also in cascading fashion, in that in a first process step the sheet 3 is initially structured or pre-damaged according to the geometry of the retaining portions 6 and in a second process step the structuring of the subregions in frames 8, connecting element 2 and element 10 is performed. Here, a corresponding selection of the process parameters—such as the pitch—makes it possible to ensure that only the elements 10, but not the perforation lines 26 between the frames 8, are released by the etching process. The embodiment of the intermediate product 1 is based on the fact that the intermediate product 1 has multiple retaining portions 6 in the form of frames 8, wherein at least one element 10 is arranged in each frame 8 and connected to the frame 8 via at least one connecting portion 2, wherein the frames 8 are connected separably to one another via one or more perforation lines 26.

In the example of FIG. 8, yet another embodiment is realized. The laser-assisted etching process which defines and works out the contour of the element 10 also makes it possible to produce alignment marks 28 in the form of through-holes. As shown in FIG. 8, in the case of multiple regions, or frames 8 connected by perforation lines, all the retaining elements 6 in the form of frames can be given such alignment marks 28. This makes it possible to easily and exactly align the frames 8 after they are separated, for instance for further-processing processes.

According to some embodiments of the method, it is intended that the ultrashort-pulse laser structuring is carried out in-line in the production process for a substrate glass. It is especially conceivable to integrate the laser structuring in-line in a continuous drawing process, during which a continuous glass ribbon is produced. It is optionally intended to combine the laser structuring with the production of thin and ultra-thin glasses with a thickness of less than 400 μm, optionally at most 200 μm, in particular at most 100 μm, or even at most 50 μm or at most 30 μm. A thin glass can be produced by a downdraw or overflow fusion method. The structured glass ribbon can be etched directly in-line. As an alternative or in addition, after the laser structuring, the glass ribbon can be wound up to form a roll or, as a result of further processes, can be separated transversely in relation to the advancement direction of the glass ribbon and thus cut to a desired length in the advancement direction. In these variants, the structuring, the etching step and possible separation can take place temporally and spatially separate from one another. To this end, FIG. 9 shows a device 29 for producing a glass ribbon, which is further developed to form a device for producing an intermediate product 1 according to this disclosure. In the example illustrated, the device 29 is designed to wind up the initially unstructured sheet 3 in the form of a continuous glass ribbon 30 to form a roll 44. First of all, a glass melt 32 is drawn out of a nozzle 34 to form a glass ribbon 30, wherein drawing rollers 36 arranged below the nozzle 34 exert a tensile force on the glass leaving the nozzle 34. The variant illustrated constitutes a downdraw method, during which the glass leaves a downwardly open nozzle. In the case of overflow fusion methods, the glass runs down over the edges of an upwardly open, elongate trough and then on the side walls of the trough. Below the trough, the sub-streams come together to form a glass ribbon.

As illustrated, the glass ribbon 30 is optionally deflected in the horizontal direction and moved by a transporting device 38, for example by conveyor belts. The structuring by introducing filamentary material modifications along a path 50, as shown in FIG. 7, subimage (b), is effected in-line on the subdivided glass ribbon 30 by an ultrashort-pulse laser 40. The laser beam 41 of the ultrashort-pulse laser 40 is focused onto the glass ribbon 30 by a beam optical unit 42 and guided over the glass ribbon 30 along the desired path 50. In the variant illustrated, the glass ribbon 30 is then wound up on a roller core 46 to form a roll 44. As an alternative or in addition, the glass ribbon 30 can be guided through an etching bath in order to expose the contour of the element 10, as shown in FIG. 7, subimage (c). The method and the device 29 according to this embodiment are thus based on the fact that
the unstructured sheet 3 made of brittle material produced is a continuous glass ribbon 30, which is produced in a continuous drawing process, wherein
material modifications are introduced on the moving, continuous glass ribbon 30 along the predetermined path 50 by the ultrashort-pulse laser 40 during the drawing process.

Since the one or more second regions 17 of the edge face 13 may have a lower strength than the first regions 15, it is advantageous to provide the second regions where generally lower mechanical loading arises. In the ideal case, a second region 17 may be located where a stress minimum is present in a defined, for example symmetrical load case. Embodiments that are provided to that end with respect to the arrangement of the one or more regions on the edge surface 13 are described below. According to some embodiments, it is provided that the at least one second region 17 extends along positions on the edge face 13 that are distant from the centroid by at least ⅔ of the maximum distance, For the same purpose, it may alternatively or additionally be provided that the at least one second region 17 extends along a portion of the edge face 13 that is subject to mechanical load in the event of loading to at most 80%, optionally at most 60%, particularly optionally at most 40% of the maximum load.

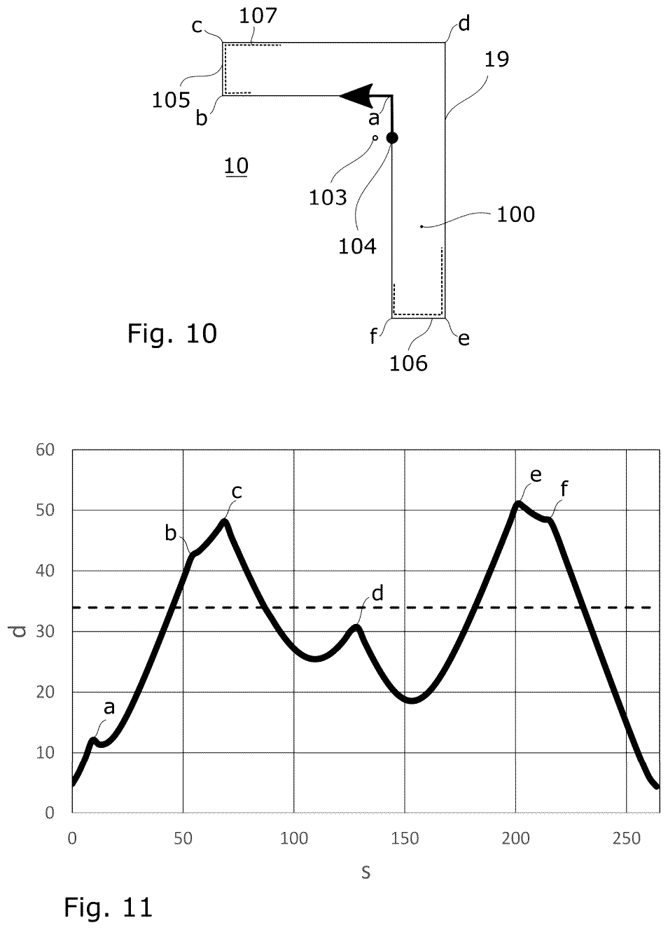

FIG. 10 shows an example of an L-shaped element 10 in a plan view of a side face 100 for illustration purposes. The centroid 103 does not have to lie within the side face 100 of the element 10. This is also the case for the illustrated element 10. For any point along the outer contour of the element 10, or the edge face 13 or the edge 19 with the coordinates (pₓ, p_{y}), the distance d from the centroid 103, which has the coordinates (mₓ, m_{y}), can be determined in accordance with d=((pₓ-mₓ)²+(p_{y}-m_{y})²)^{1/2}.

FIG. 11 shows, for the element from FIG. 10, a diagram of the distance d of the position of the edge face or contour to the centroid as a function of the travel s along the contour of the element 10. The point 104, which is the point of the contour minimally spaced apart from the centroid 103, is selected as starting point. The arrow indicates the direction along which the contour was followed. The corner points of the contour are denoted with the letters a, b, c, d, e, f in FIG. 10. These points are denoted in the same way in the diagram of FIG. 11 and can be clearly seen as peaks. The maximum distance from the centroid 103 is at the corner e. In FIG. 11, a dashed line marking a value of ⅔ of the distance at the point e is drawn. In the scale of FIG. 11, the corner e has a distance of approximately 51 (in arbitrary units). The limit of ⅔ of this value is accordingly at approximately 34. Accordingly, the preferred positions for the connection to a connecting portion 2 in the example illustrated are at the ends of the legs 105, 106. The preferred fastening regions 107 are marked with a dashed line for illustration purposes. As can also be seen on the basis of the diagram of FIG. 11, although the corner d is also relatively far away from the centroid 103, the condition of a distance of at least ⅔ of the maximum distance is not enough. In fact, this region would also be less suitable for fastening to a connecting portion 2, since a fractured surface in the region of the corner d can be subject to tensile stress loading in the event of mechanical loading being applied to the legs 105, 106.

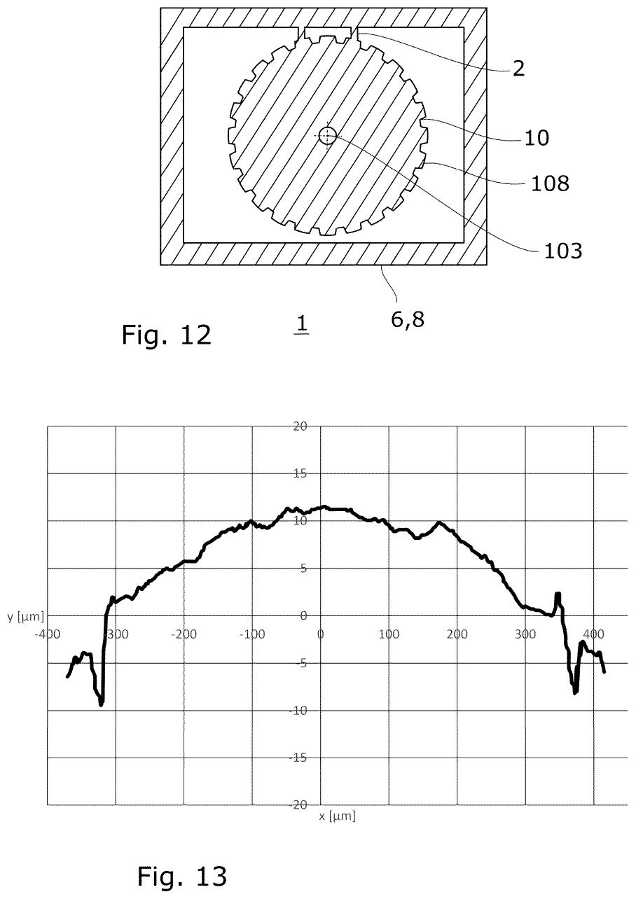

FIG. 12 shows another example, in which the arrangement of the second regions, or in the case of the intermediate product 1 the position of the connection of the element 10 to the retaining portion 6 via the one or more connecting portions 2, meets the aforementioned structural requirement. In this respect, FIG. 12 shows an intermediate product 1 with a retaining element 6 in the form of a frame. In the opening of the frame, an element 10 in the form of a gearwheel is connected to the frame 8 via two connecting portions 2. The connecting portions 2 are connected to the element 10 at the outer edge of the teeth 108. These parts of the contour are at a greater distance from the centroid 103 than the indentations between the teeth 108. These outer regions of the teeth 108 moreover are at the maximum distance from the centroid 103 in the center of the gearwheel.

In general, it is not only possible to create edge faces with a rectilinear profile, in particular with a profile extending substantially perpendicularly in relation to the side faces 100, 101. Rather, it is also possible to create edge faces with a curved profile, or cross section. In addition to an inwardly curved, that is to say concave profile, it is in particular also possible to produce an outwardly curved profile. To that end, FIG. 13 shows a height profile of an edge surface 13 of an element 10 inside a first region 15. The steep drops in the height profile to the minima at the x-positions of approximately −321 μm and +372 μm mark the position of the side faces 100, 101.

As can be seen from the profile, the edge face curves outward by a magnitude in the range of 10 μm to 15 μm. Such profiling can generally also be achieved by introducing the filamentary damage in completely or partially oblique fashion. As an alternative or in addition, the etching rate at which material is removed can be influenced by generating filamentary damage that ends at least on one side in the material.

Without being restricted to the specific exemplary embodiment, it is provided to this end that the edge face 13 with the etched surface in the first portion has a profile which curves outward or inward by at least 1% of the thickness of the element 10.

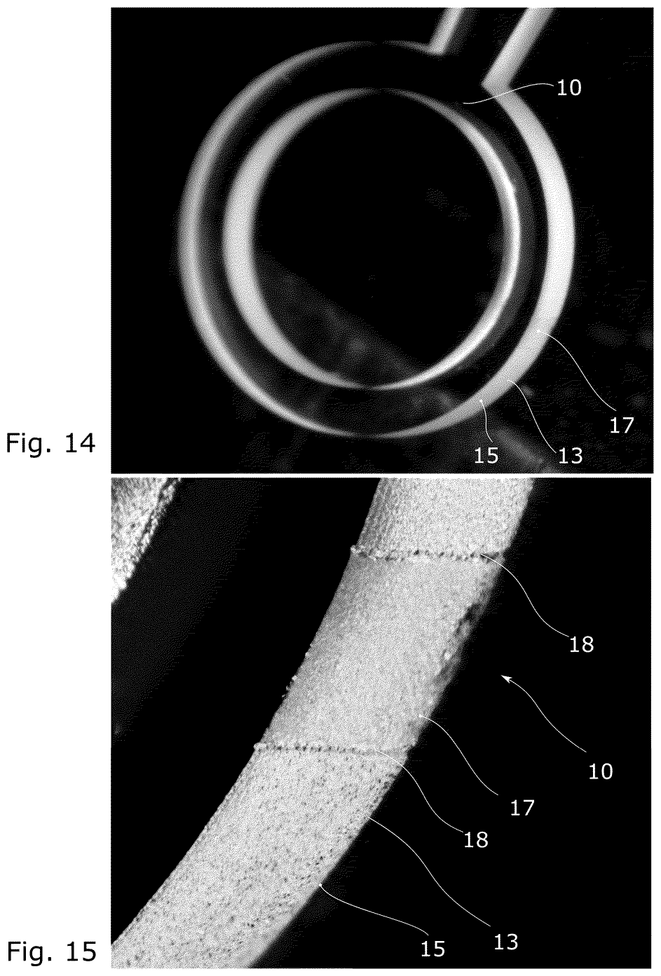

FIG. 14 and FIG. 15 are optical micrographs of an element made of glass. The edge face 13 of the element 10 is outwardly curved, as in the example of FIG. 13. As shown in FIG. 14, the element 10 has an annular part, adjoining which is a rod-like portion, which can be seen at the top right in the image. The two regions 15, 17 can scarcely be distinguished visually in the micrograph of FIG. 14. FIG. 15 shows a further-enlarged micrograph of the edge face 13 with the regions 15 and 17. The transitions 18, discernible as lines, between the regions 15, 17 are visible here especially. In any case, the fractured edge of the second region 17 can scarcely be distinguished visually from the etched surface of the first region here, too. This is in particular due to the fact that the roughness of the two regions can be matched to one another. As a result, the roughness of the first region can be influenced by the etching parameters. In the second region 17, the roughness can be influenced, among other things, by the type and shape of the weakening structure 4, for example the distance between instances of filamentary damage along a weakening line. Without being restricted to the example shown, in some embodiments it is therefore provided that the ratio of the mean roughness value Ra of the first region 15 and an adjacent second region 17 is in the range from 0.75 to 1.25. As in the example illustrated, according to some embodiments, the two regions 15, 17 have an appearance similar to that of a ground surface. In particular, the two regions can thus generally have the same visual appearance, without being restricted to the example illustrated.

Since the second region 17 optionally constitutes a fractured edge, it typically has a flat form. However, it is also possible here to achieve a different, for instance convexly or concavely curved shape, with certain measures. For example, to this end, multiple instances of filamentary damage could be introduced at different angles.

In order to visually match the two regions 15, 17, it is also advantageous if the height offset between a second region 17 and an adjacent first region 15 is less than 20 μm. This feature is likewise satisfied in the example shown in FIGS. 14 and 15. The second region 17 neither protrudes nor is appreciably recessed. This feature can be realized by having a weakening structure 4 on the connecting portion 2 end close to the outer contour in the adjacent first region 15, or continue this outer contour.

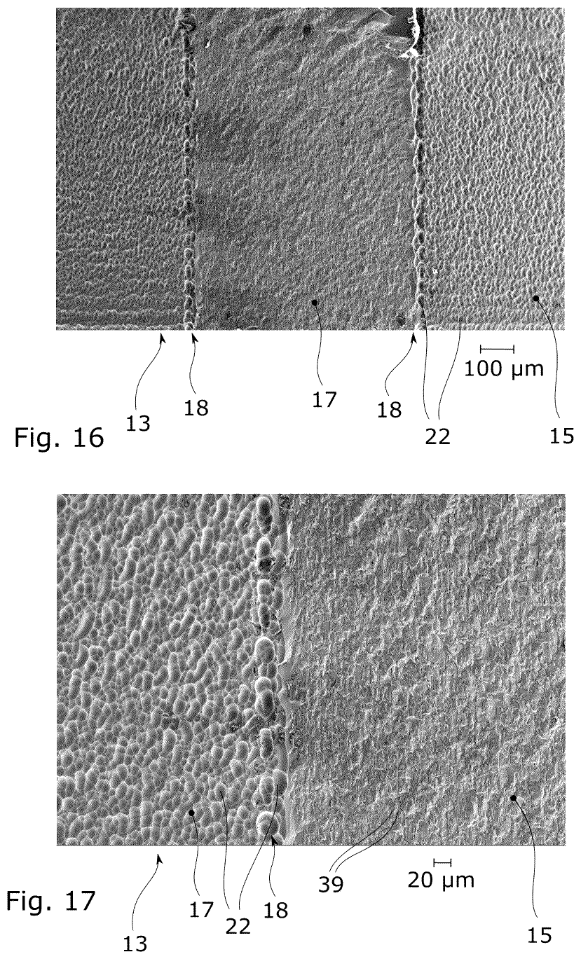

FIGS. 16 and 17 show two electron micrographs of the edge face 13 of an element 10 made of brittle material, in this case specifically, and similarly to the examples of FIGS. 14 and 15, elements made of glass.

The example of FIG. 16 was taken at 200 times magnification. The second region 17, adjoining which on the left and right are first regions 15, can be clearly seen here. The calotte-shaped depressions 22 in the first region can also be clearly seen. According to some embodiments, which is also realized in the example illustrated, a respective transition 18 between the first region 15 and the second region 17 is also present, wherein the transition 18 has calotte-shaped depressions which on average are larger than the calotte-shaped depressions of the first region. The larger depressions 22, extending along the transition 18, can be clearly seen in the micrograph. The production of the depressions can be attributed to a change in the etching rate at the transition between the connecting portion 2 and the element 10 when the contour is being worked out in the etching bath. These larger calottes are advantageous in order to avoid an uncontrolled fracture or chipping when the element 10 is being separated from the connecting portion 2.

FIG. 17 shows the edge face at 500 times magnification. In the case of this magnification, the filamentary damage 39 introduced by the ultrashort-pulse laser in the fractured surface of the first region 17 can also be seen as fine, dark, straight lines, since the fractured surface extends along the filamentary damage. The damage is therefore accordingly present in the form of partially half-open channels in the fractured surface. In the image of FIG. 17, the filamentary damage 39 runs from top to bottom, that is to say in the direction from a side face to the opposite side face of the element 10. The distance between instances of filamentary damage 39 is approximately 6 μm in the example illustrated. As explained above, optionally first of all the contour of the sheet-like intermediate product with the connecting portion 2 and the element 10 is worked out by filamentation and etching. Shortly thereafter, the filamentary damage 39, which forms the weakening structure 4 and which is thus visible in the fractured surface of the second region, is introduced. However, other variants are also conceivable, for instance introducing all the filamentary damage and subsequently masking the damage 39 in the connecting portion 2, in order to avoid etching this damage 39 open.

In some embodiments, the intermediate products 1, as shown for instance by way of example in FIG. 4 to FIG. 6, are coated after the structuring process (laser filamentation and subsequent etching process). Accordingly, it is then also the case the element 10 separated from the intermediate product can be provided with a coating, in particular an optically active coating.

Different coating methods such as sputtering and PVD, dip coating or printing the components and retaining portions as a whole are possible in principle. Different types of applied layers are also conceivable, such as optically active layers (antireflection layers, filter layers, for example IR cut filters), functional layers (anti-fingerprint, antimicrobial or antibacterial coatings (such as on the basis of silver ions), scratch-resistant coatings, or else purely decorative coatings in the form of applied paints or lacquers. Suitable for scratch-resistant coatings are typically layers with a high refractive index and layer thicknesses of 1 μm and more, for instance on the basis of aluminum/silicon nitride or zirconium oxide.

For IR cut or bandpass filters, multilayer systems alternately composed of a coating with a high refractive index (usually TiO₂, Ta₂O₅, Nb₂O₅, HfO₂, ZrO₂) and a coating with a low refractive index (optionally SiO₂) of suitable thickness can be combined in order to achieve the desired optical properties. Such multilayer systems can also be used for other coatings, such as antireflection coatings. Without being restricted to specific examples, in some embodiments it is therefore provided that the optically active coating comprises multiple layers with different refractive indices, in particular with alternating layers of high refractive index and low refractive index relative thereto.

The method described here makes it possible to manufacture and handle particularly small components, in particular with lateral dimensions in the range of 1 mm to at most 10 mm and with a thickness of the substrate material of 50 μm, at least however 70 μm to 400 μm. One possible application of such a small element is use as an IR cut filter, for example for a camera sensor in a mobile telephone or in camera modules, like in other portable electronic devices, such as laptops or tablet PCs. To that end, generally an optically active layer with the required optical properties is applied. The deposition of the layer is facilitated, or even only enabled in the first place, by the predefined positioning of the elements 10 by the connecting portions 2 and retaining portions 6.

Among other things, the strength of the element also continues to be an important variable for this aforementioned field of application. A high-strength filter element is manufactured in this case by suitably combining a coating process, which adjoins the structuring process, with an upstream or downstream prestressing process.

The coating of elements and the possibility of also identifying the orientation of the separated coated elements 10 on the basis of the regions 15, 17 by a robot, and the prestressing were already described above.

According to some embodiments provided according to the invention, it is therefore generally the case that a sheet-like optical filter element is provided, in the case of which the element 10 made of brittle material is coated with an optical filter coating. In this respect, at least one of the side faces 100, 101 can be provided with the optical filter coating; if appropriate, a coating on two sides can also be provided. In this case, the coatings may also differ. The optical filter coating may be an IR cut coating, that is to say a coating which in particular absorbs or reflects radiation in the near-infrared range. It is typical for such an optical filter element in this respect for the substrate, or the element 10, to be transparent to the infrared radiation, or more generally to have a higher transmittance for the infrared radiation than the filter coating does. The near-infrared range is to be understood to mean a wavelength range of 0.7 μm to 2.5 μm within the context of the IR cut coating function. According to yet another embodiment, in general a camera module is provided which has a sensor covered by a sheet-like element 10 according to this disclosure, wherein the sheet-like element 10 forms an optical filter. In particular, to this end, as described above, an optical filter coating can be provided on the element 10. As an alternative or in addition, the glass of the sheet-like element 10 may also be a filter glass.

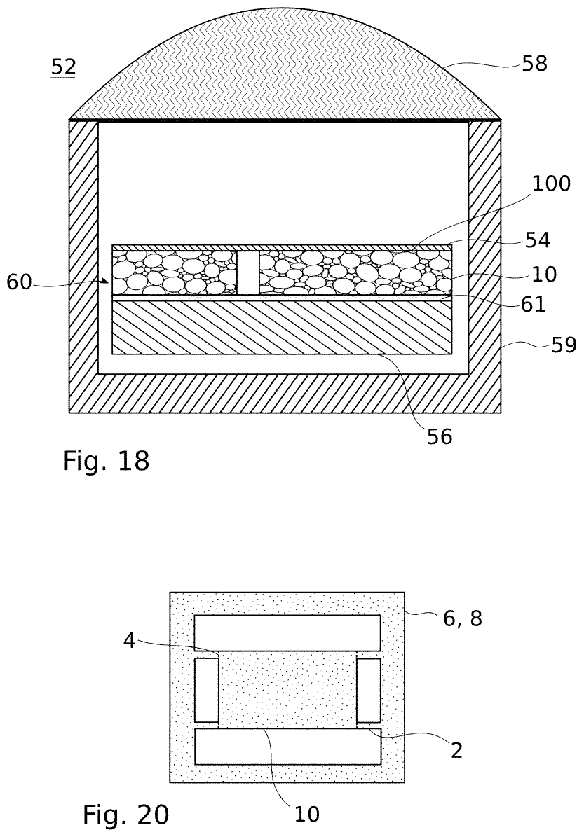

In relation to this embodiment, FIG. 18 shows a camera module 52, as can be used for example in a mobile telephone or another portable electronic device. The camera module 52 comprises a camera sensor 56 for taking images, a lens 58 and possibly a housing 59 for receiving and fastening the sensor 56 and the lens 58. An optical filter element 60 is applied to the light-sensitive layer of the sensor 56, for example adhesively bonded by a bond layer 61. The optical filter element 60 is formed by a coated element 10. In this case, the optical filter coating 54 is formed such that the radiation in the near-infrared range is largely reflected or absorbed, so that substantially only visible light is incident on the sensor.

In a further embodiment, the coating process precedes a prestressing operation, optionally chemical prestressing of the substrate. To this end, the one or more retaining portions 6 and frames 8, and connecting portions 2, or the sheet-like, brittle intermediate product 1 with the aforementioned parts of the whole, are subjected to the prestressing process in the exchange bath.

The strengths of the components both in the bond to the retaining portion and after the leaching out are very important. The strengths are decisively determined by the breaking strengths of the respective edges in this respect. For this, the Weibull diagrams in FIG. 19 show typical values for the edge strength of a very thin glass which is 100 μm thick, measured directly after the filamentation, that is to say the introduction of filamentary damage by an ultrashort-pulse laser (measured values “A”, circular symbols). Also shown are measured values for glass sheets after a subsequent KOH etching process (measured values “B”, triangular symbols) and after a chemical prestressing process following the etching process (measured values “C”, rhomboidal symbols). The glass sheets were produced from a glass of type D263T.

The lines drawn in FIG. 19 represent functions, adapted to the measured values, of the probability of failure H in the form H=100%·(1−exp(−t/T)^{b}). The straight lines accordingly represent the cumulative density functions of the probability of fracture, with the shape parameter b and the scale parameter T. For the measured values “A”, after filamentation, this affords T=53.55, b=25.25; for the measured values “B”, after etching, this affords T=826.35, b=1.69; and for the measured values “C”, that is to say after etching and prestressing, this affords T=508.8, b=8.27.

While the filamented edge of the ultra-thin glass substrate (measured values “A”) has a minimum breaking stress of approximately 50 MPa, in the case of etched edges (measured values “B”) at least approximately 200 MPa is attained, and in the case of the prestressed edges (measured values “C”) even more than at least approximately 300 MPa is attained. The prestressing process makes the width of the distribution of the breaking stresses of the etched edges considerably smaller, that is to say more defined: The mean breaking stress of the etched and prestressed edges is approximately 500 MPa.

The strength increase caused by the prestressing process is independent of the material and it is generally possible to obtain considerably higher strength values over non-prestressed glass sheets, as shown in the example of FIG. 19.

These values are important for the process for separating an in particular also small component, or element 10, from the retaining frame 8, or from the material bridge, that is to say the connecting portion 2: If a weakening structure 4 is introduced into the narrow material bridge, its strength corresponds somewhat to the reference value for the filamented edge (measured values “A”), and therefore its strength is less than the strength of the etched edge (with respect to the characteristic b10 value) approximately by a factor of 4. If the components were also subjected to a prestressing process, this interval increases further to a factor of 6. Therefore, during the singulation, initially material bridges fracture in the region of the weakening structure 4 and the component 10 can be reliably separated from the retaining portion 6 in particular in the form of a frame 8. This effect enables easy separation of the element 10 from the frame 8 even after a chemical prestressing operation. In an advantageous embodiment, what is therefore provided is a sheet-like intermediate product 1 in the case of which a weakening structure 4 extends along an intended separation line between the connecting portion 2 and the element 10, wherein the weakening structure 4 has a chain of filamentary damage and wherein the intermediate product 1 is chemically prestressed. In this case, both the element 10 and at least the connecting portion 2 are chemically prestressed in the region of the weakening structure 4.

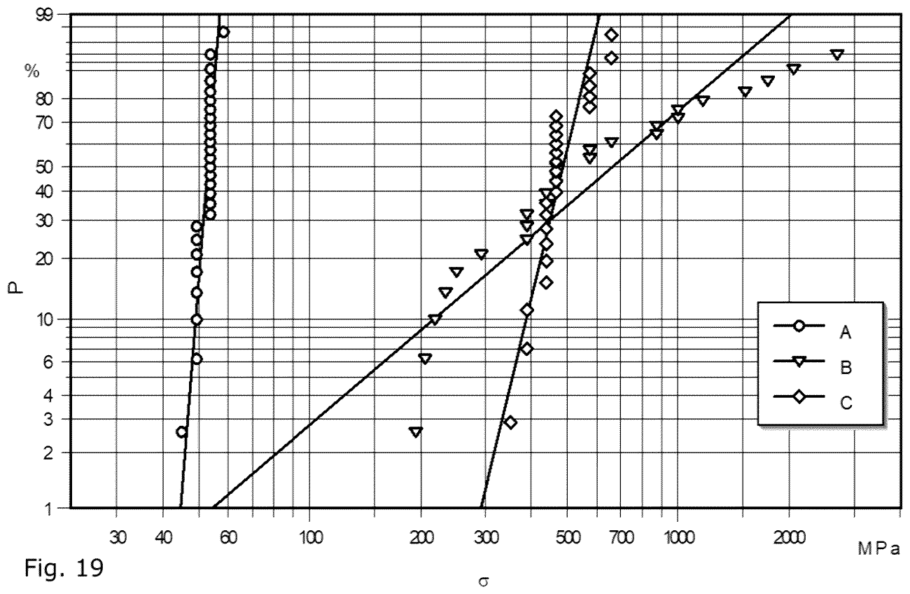

If an intermediate product 1 coated and/or prestressed according to this disclosure is separated at the one or more retaining portions 6, or material bridges, the second regions 17 of the edge face 13 that are already described above are produced, these second regions possibly differing from the first regions 13 of the edge face not only, as already described, in terms of roughness values but also in terms of their coating state and their strength. The possibly reduced strength of the edge face in the two regions 17 seems to be appropriate in particular in the case of a prestressed and coated intermediate product 1, in that the material bridges/connecting portions 2 make contact with the edge face of the element 10 in those regions in which the reduced strength of the element 10 is acceptable for later use. Therefore, in the case of a rectangular element 10, the connecting or retaining portions 6 are optionally arranged in the region of the corners or directly at the corners of the element 10, since the smallest stresses arise there in the event of loading. FIG. 20 shows an intermediate product 1 with correspondingly arranged connecting portions 2. By contrast to the exemplary embodiments of FIGS. 3 to 8, here the connecting portions 2 directly adjoin the corners of the element 10, which is rectangular here. If the element 10 is then separated from the retaining portion 6, what is generally obtained, without being restricted to the example illustrated, is an element 10 with a shape having at least one corner, wherein a second region 17 of the edge face is present, the one edge of which coincides with the corner of the element 10, or wherein the second region 17 ends at the corner. It is also possible for a small distance to remain between the edge of the region 17 and the corner, to like effect. According to a more general embodiment, in this case the distance from the edge of the second region to the corner is less than the width of the second region 17, optionally less than half the width of the second region 17.

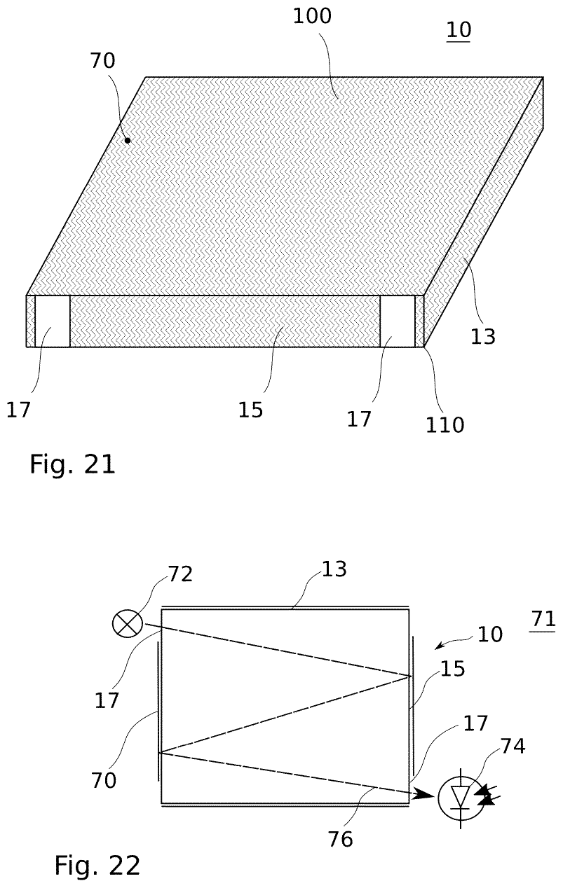

FIG. 21 shows one exemplary embodiment with such an element 10. In this example, the two regions 17 do not end directly at the respective corners 110, but instead at a small distance therefrom. The distances are, however, less than the width of the second regions 17, or even less than half the width of the second regions 17. A small distance, as in the example illustrated, can be advantageous in order to prevent material breaking out at the corner 110 during the detaching operation and the resulting fractured surface of the second region becoming uneven. As described above, the intermediate product 1 can be coated prior to the separating of an element 10. The second regions 17 that are exposed on the material bridges by the separation process for a coated intermediate product 1 then accordingly do not have a coating. This embodiment is likewise illustrated in FIG. 21. The coating 70 is illustrated as a hatch pattern here. As shown, the coating 70 may at least partially also be present on the edge face 13. In general, without being restricted to the illustrated specific example, according to yet another embodiment an element 10 made of brittle material is thus provided, in the case of which at least one of the side faces 100, 101 and the edge face 13 is at least partially provided with a coating 70, wherein the coating 70 is omitted, or missing, on the second region 17.

In a further embodiment, second regions produced in this way can therefore be used later on—possibly after post-processing of the faces—for the incoupling and/or outcoupling of electromagnetic radiation, in particular visible (coherent or incoherent) electromagnetic radiation. Such elements are used for example as light guide components or else in biotechnology as microfluidic elements. According to yet another embodiment, it is thus generally the case, without being restricted to the presence of certain coatings, that an electro-optical arrangement comprising at least one radiation source and/or a sensor is provided, wherein the radiation source and/or the sensor are arranged such that radiation is incoupled, or outcoupled for detection by the sensor, from the radiation source through the at least one second region 17 on the edge face 13 of the element 10 made of brittle material.

Overall, in addition to the already described change in the roughness values in the second regions 17 of the edge 13 of the intermediate product with respect to the surrounding first regions 15, the lack of coating and the reduced strength in these second regions also indicate the use of the method according to the invention. In a further embodiment, the transition region between the element 10 and the material bridge, or connecting portion 2, is provided with a weakening structure 4 along the intended contour of the element 10 and then coated, for example with Cr/CrO, by a sputtering process or another PVD method. Owing to the small thickness of the intermediate product, it can be observed here that not only the side faces 100, 101 of the intermediate product 10, but also, as described above, its peripheral edge face 13—at least partially—and—if the diameter of the weakening structure 4 after the etching process is large enough—also the inner faces of the individual elements of the weakening structure 4 are coated. After the element 10 is separated from the one or more connecting portions 2, the edge face has the aforementioned properties, that is to say an edge face 13 which is subdivided into first and second portions 15, 17 corresponding to the number of material bridges and which has the aforementioned coating at least outside the regions of the material webs, that is to say in that case on the first regions 15, and optionally also residues of the coating 70 in the second regions 17. To identify the first and second regions of the edge face 13, it is in particular also possible to make use of the different optical properties with respect to reflection/scattering. An element 10 produced in this way then makes it possible, among other things, to realize an electro-optical arrangement, as described below.

FIG. 22 shows an example of an electro-optical arrangement 71 with an element 10. The electro-optical arrangement 71 comprises a radiation source 72 and a radiation sensor 74. The element 10 has a coating 70 which is also present on the edge face 13, but is not present in the second regions 17, as described above. For example, the coating 70 may have a radiation-reflecting form. The radiation from the radiation source 72 can then be incoupled into the element 10 through a second region 17 and exit again through another second region 17, in order to be detected by a radiation sensor 74. A possible radiation path is depicted on the basis of an exemplary light beam 76. If, for instance, one of the side faces of the element 10 is also not coated, here it is possible for the radiation to interact with a medium.

Refinements of the method for producing an element 10 made of brittle material will be described below. A basic concept of the method consists in making it easier to handle the elements 10 by virtue of the bond to the retaining portion 6. At the latest with the separation at the connecting portion 2, the element 10 is singulated and from this point on, in turn, handling can be more difficult. In order to improve this further, according to some embodiments of the method it is generally provided that the intermediate product 1 is fastened on a carrier. According to a first refinement, the element 10 is separated from the retaining portion 6 while the element 10 is fixed on the carrier, and wherein the element 10 in particular also remains connected to the carrier after being separated. This makes it possible to be able to detach the element 10 from the carrier at a suitable later point in time, without the retaining portion 2 needing to be separated at this point in time. According to an alternative or additional refinement, the carrier is deformable, wherein the element 10 is separated from the connecting portion 2 by generating a mechanical stress in the connecting portion 2 as a result of deformation of the carrier. The deformation can comprise stretching the carrier and/or bending the carrier. In the case of bending, a bending stress is exerted on the connecting portion 2, since the intermediate product 1 is conjointly bent due to being fixed on the carrier. If the carrier is stretched, a tensile stress is produced at the connecting portion 2 in the direction along the surface of the intermediate product 1.

The aforementioned refinements are explained in more detail below on the basis of examples. In general, the carrier may be in the form of a film. The intermediate product 1 can then be applied to a carrier in the form of a strip-like film, to the greatest possible extent avoiding the formation of air bubbles or other pockets. The film, for its part, can be fastened to a further retaining frame (for example made of steel), with the result that there is a strip stress in the film which is as constant as possible. The element 10 is thus also fixed in place and secured during the subsequent separating process. The element 10 can then be separated from the retaining portion 6 by a wide variety of different method variants:

A) Stretching the Film:

The geometric shape of the film retaining frame is determined by the geometric shape of the assembly and of the necessary stretching direction(s) during the separating process: While in the case of a round assembly isotropic, i.e. angle-independent, stretching of the film that is the same in all directions is preferred, in the case of rectangular assemblies, by contrast, directed, uniaxial stretching of the film is suitable in order to use the stretching of the film to transfer a mechanical tensile stress into the region of the material weakenings or in general to the connecting portion 2, and thus separate the element 10 from the retaining portion 2.

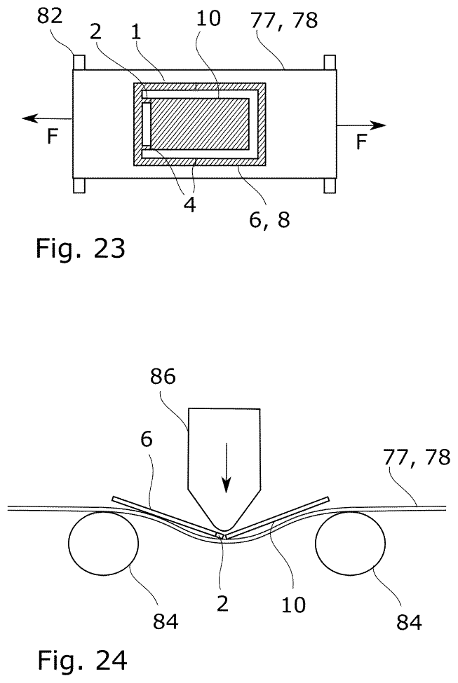

FIG. 23 shows a corresponding arrangement. The intermediate product 1 is fixed on a carrier 77 in the form of a stretchable film 78. The film 78 for its part is clamped by a clamping device 82. The clamping device 82 may for example comprise a suitable retaining frame. The clamping device 82 can then be used to exert a force on the film 78, as symbolized by the arrow denoted “F”. As a result, the film 78 is stretched and transfers the force as tensile stress to the intermediate product. The tensile stress accordingly extends along the surface of the intermediate product and leads to separation at the one or more connecting portions 2. Especially in the case of a retaining portion 6 in the form of a frame 8 surrounding the element 10, as in the example illustrated, the separation can be facilitated if the frame 8 also has one or more weakening structures 4. In this way, when the film is stretched or expanded, initially the frame 8 is separated, so that the expansion is also transferred to the connection between the element 10 and the retaining portion 6.

B) Bending:

A further option consists in mechanically bending the carrier and/or the intermediate product 1 fixed on the carrier along the weakening structures or, more generally, at the connecting portion 2. For example, use can be made of a three-point bending process in which, from one side of the arrangement of carrier and intermediate product, two support bars/blades are used to provide support in the region on the right and left of the weakening structure 4 or the connecting portion 2, while from the opposite side a blade subjects the connecting portion itself to mechanical load and leads to the fracture at the connecting portion 2, optionally at a weakening structure 4. This process can—depending on the arrangement and fixing of the elements 10 at the one or more retaining portions—also be carried out successively in different directions. The example in FIG. 24 shows a corresponding arrangement. The carrier 77, for example again in the form of a film 78 or another deformable underlayer, is placed on two spaced-apart supports 84, with the result that the connecting portion 2 of the intermediate product fixed on the carrier 77 is located between the supports 84. A blade 86 presses on the carrier 77 with the intermediate product from the opposite side of the supports, with the result that the carrier 77 together with the intermediate product is bent and a bending stress in the region of the connecting portion 2 is brought about. In this respect, FIG. 24 shows the retaining portion 6 and the element 10 already in the separated state.

Further embodiments of the mechanical bending may be to draw the component-bearing film through a trough—for example using negative pressure—or optionally to lead it through a raised, for example rounded structure, in order as a result to transfer a mechanical stress to the connecting portion between the element 10 and retaining portion 6 and trigger the separating operation.

Suitable films 78 may be in the form of single-layer or multilayer films. Generally, they comprise at least one carrier film and a pressure-sensitive adhesive film, possibly also a further separating film. The adhesive tape used can be blue tape or—in the case of elements 10 with a very complex structure—even UV-curing tape. The bonding capability of the adhesive tape should be great enough to retain the components, or elements 10, during the processing processes, but still make it possible to detach the singulated components from the film without damaging them. In particular the UV-curing film is particularly suitable here, since it has a good bonding capability in the non-cured state, while the bonding capability is reduced by the curing process and makes it possible to detach the component. Yet another option is also to fix the intermediate product 1 on the carrier 77 electrostatically.

It is evident to those skilled in the art that the embodiments are not restricted to the specific exemplary embodiments illustrated and described, but instead can be modified and combined in a wide variety of ways. As a result, among other things, the separating methods described above can also be combined with one another, for instance to separate the elements 10 at differently positioned connecting portions 2.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE SIGNS

| | |
|---|---|
| 1 | Sheet-like intermediate product |
| 2, 20 | Connecting portion, material bridge |
| 3 | Unstructured sheet |
| 4 | Weakening structure |
| 5 | Material modification |
| 6 | Retaining portion |
| 8 | Frame |
| 9 | Opening in 8 |
| 10 | Element made of brittle material |
| 11 | Contour of 10 |
| 12 | Opening in 10 |
| 13 | Edge face of 10 |
| 14 | Element that complements element 10 |
| 15 | First region of 13 |
| 17 | Second region of 13 |
| 18 | Transition between 15, 17 |
| 19, 20 | Edges of 10 |
| 22 | Calotte-shaped depression |
| 24 | Ridge |
| 26 | Perforation line |
| 28 | Alignment mark |
| 29 | Device for producing a glass ribbon |
| 30 | Glass ribbon |
| 32 | Glass melt |
| 34 | Nozzle |
| 36 | Drawing rollers |
| 38 | Transport direction |
| 39 | Filamentary damage |
| 40 | Ultrashort-pulse laser |
| 41 | Laser beam |
| 42 | Beam optical unit |
| 44 | Roll |
| 46 | Roller core |
| 50 | Path |
| 52 | Camera module |
| 54 | Optical filter coating |
| 56 | Sensor |
| 58 | Lens |
| 59 | Housing |
| 61 | Bond layer |
| 70 | Coating |
| 71 | Electro-optical arrangement |
| 72 | Radiation source |
| 74 | Radiation sensor |
| 76 | Light beam |
| 77 | Carrier |
| 78 | Film |
| 80 | Inner-edge face of 8, 9 |
| 82 | Clamping device |
| 84 | Support |
| 86 | Blade |
| 100, 101 | Side faces of 10 |
| 103 | Centroid of 10 |
| 104 | Point minimally spaced apart from 103 |
| 105, 106 | Leg |
| 107 | Fastening region |
| 108 | Tooth |
| 110 | Corner of 10 |

What is claimed is:

1. A sheet-like element made of brittle material, comprising:
two opposing side faces; and
a peripheral edge face which determines an outer contour of the sheet-like element, wherein the edge face has at least one first region and at least one second region, wherein the at least one first region differs from the at least one second region in terms of its surface structure, wherein the at least one first region has an etched surface and the at least one second region constitutes a fractured surface, and wherein a surface area of the at least one first region is larger than a surface area of the at least one second region, wherein the at least one first region and the at least one second region are arranged next to one another in a direction along the edge face.

2. The sheet-like element of claim 1, wherein the brittle material is a glass or a glass ceramic.

3. The sheet-like element of claim 1, wherein at least one of the following is satisfied:
the at least one second region of the edge face adjoins at least one edge at which the edge face merges into the side faces; or
the etched surface of the at least one first region has calotte-shaped depressions which adjoin one another, with the result that adjacent depressions are separated by ridges.

4. The sheet-like element of claim 1, wherein at least one of the following is satisfied:
the at least one second region has a width of at least 0.5% of a largest lateral dimension of the sheet-like element;
the at least one second region has a width of at least 20 μm;
a sum of one or more area percentages of the at least one first region takes up a proportion of an overall surface area of the edge face of at least 90%;
the largest lateral dimension of the sheet-like element is at most 100 mm;
the largest lateral dimension is at least 1 mm;
a contour of the sheet-like element is convexly shaped adjoining the at least one second region; or
a number of the at least one second region is at most 50.

5. The sheet-like element of claim 1, wherein at least one of the following is satisfied:
the at least one second region extends along positions on the edge face that are distant from a centroid by at least ⅔ of a maximum distance; or
the at least one second region extends along a portion of the edge face that is subject to mechanical load in the event of loading to at most 80 of a maximum load.

6. The sheet-like element of claim 1, wherein at least one of the following is satisfied:
the at least one second region is flat;
a height offset between one of the at least one second region and an adjacent one of the at least one first region is less than 20 μm;
a ratio of a mean roughness value Ra of one of the at least one first region and an adjacent one of the at least one second region is in a range from 0.75 to 1.25;
there is a transition between the at least one first region and the at least one second region, wherein the transition has calotte-shaped depressions which on average are larger than calotte-shaped depressions in the at least one first region;
the at least one first region and the at least one second region have a same visual appearance;
the at least one second region of the edge face ends at a corner of the sheet-like element;
a distance from an edge of the at least one second region to a corner of the sheet-like element is less than a width of the at least one second region; or
a strength of the sheet-like element with respect to torsional loading of the edge face is at least 20 MPa higher in the at least one first region than in the at least one second region.

7. The sheet-like element of claim 1, further comprising an optically active coating.

8. The sheet-like element of claim 7, wherein at least one of the following is satisfied:
the sheet-like element is coated with an optical filter coating on at least one of the side faces, wherein the sheet-like element has a higher transmittance for infrared radiation than the optical filter coating does;
the optically active coating comprises multiple layers with different refractive indices; or
at least one of the side faces and, at least partially, the edge face are provided with a coating, wherein the coating is omitted on the at least one second region.

9. A sheet-like intermediate product made of brittle material for producing a sheet-like element, comprising:
a retaining portion; and
an element connected to the retaining portion via at least one connecting portion, wherein the element and the at least one connecting portion have an edge face with an etched surface, and wherein a width of the at least one connecting portion at a transition to the element is smaller than a length of a contour formed by the edge face with the etched surface, with the result that, by virtue of separating the element by fracturing the brittle material at the at least one connecting portion, it is possible to obtain a separate element made of brittle material, the edge face of which has at least one first region and at least one second region, wherein the at least one first region differs from the at least one second region in terms of its surface structure, wherein the at least one first region has an etched surface and the at least one second region constitutes a fractured surface, and wherein a surface area of the at least one first region is larger than a surface area of the at least one second region, and wherein the at least one first region and the at least one second region are arranged next to one another in a direction along the edge face.

10. The sheet-like intermediate product of claim 9, wherein at least one of the following is satisfied:
the retaining portion is larger in terms of at least one lateral dimension than the at least one connecting portion or the element made of brittle material;
the at least one connecting portion has a width of at least 0.5% of a largest lateral dimension of the element made of brittle material;
the at least one connecting portion has a width of at least 20 μm; or
the width of the at least one connecting portion is at most 50% of a largest lateral dimension of the retaining portion or the largest lateral dimension of the element made of brittle material.

11. The sheet-like intermediate product of claim 9, wherein multiple elements made of brittle material are arranged in a side-by-side arrangement in a matrix arrangement with more than one row of elements made of brittle material.

12. The sheet-like intermediate product of claim 9, comprising at least two elements made of brittle material inside an opening of a retaining portion in the form of a frame, wherein the at least two elements made of brittle material are connected to one another by at least one connecting portion that extends from one of the at least two elements to another one of the at least two elements.

13. The sheet-like intermediate product of claim 9, wherein an element is connected to the retaining portion by at least two connecting portions, wherein at least one of the following is satisfied:
a mutual distance between the at least two connecting portions is at least 20 μm;
the mutual distance between the at least two connecting portions is at least half a thickness of the intermediate product; or
the element is connected to the retaining portion by two parallel connecting portions.

14. The sheet-like intermediate product of claim 9, further comprising a weakening structure that extends along an intended separating line between the at least one connecting portion and the element.

15. The sheet-like intermediate product of claim 14, wherein the weakening structure has at least one of the following features:
a score line,
a chain of through-holes or filamentary damage; or
a region of lower thickness.

16. The sheet-like intermediate product of claim 9, wherein the sheet-like intermediate product comprises multiple retaining portions in the form of frames wherein at least one element is arranged in each frame and is connected to the frame via at least one of the at least one connecting portions, wherein the frames are connected separably to one another via one or more perforation lines.

17. A method for producing a sheet-like element made of brittle material, comprising:
providing a sheet made of brittle material;
irradiating the sheet made of brittle material with a laser, wherein the brittle material of the sheet is at least partially transparent to the laser, wherein a laser beam of the laser causes material modifications inside the sheet, and wherein the laser beam is guided over the sheet along a path so that the material modifications lie next to one another on the path;
subjecting the sheet to an etching process after irradiating the sheet, wherein the material modifications are enlarged by the etching process to form channels which are lastly connected, with the result that the sheet is separated along the path and the path defines a contour of an element which is connected to a retaining portion via a connecting portion, with the result that a sheet-like intermediate product is obtained; and
separating the connecting portion so that the element is detached from the retaining portion.

18. The method of claim 17, further comprising introducing a weakening structure that extends along an intended separating line between the connecting portion and the element.

19. The method of claim 17, wherein the provided sheet made of brittle material is a continuous glass ribbon that is produced in a continuous drawing process, and wherein material modifications are introduced on the continuous glass ribbon along the predetermined path by the laser during the drawing process as the continuous glass ribbon moves.

20. The method of claim 17, wherein the sheet-like intermediate product is fastened on a carrier, the method further comprising at least one of the following:
separating the element from the retaining portion while the element is fixed on the carrier, wherein the element also remains connected to the carrier after being separated;
deforming the carrier so the element is separated from the connecting portion by generating a mechanical stress in the connecting portion as a result of deforming the carrier;
stretching the carrier so that a tensile stress is exerted on the connecting portion; or
bending the carrier or the intermediate product fixed thereon so that a bending stress is exerted on the connecting portion.
